(19) United States
(12) Patent Application Publication
(10) Pub. No.: US 2026/0051746 A1
(43) Pub. Date: Feb. 19, 2026

(54) CHARGING CIRCUIT, CHARGING METHOD, AND SYSTEM FOR ENERGY STORAGE CAPACITOR

(71) Applicant: Robert Bosch GmbH, Stuttgart (DE)

(72) Inventors: Xiaofei Qiu, Suzhou (CN); Mengyi Wang, Suzhou (CN); Wenda Li, Suzhou (CN); Xuewei Wang, Suzhou (CN); Xueting Zhang, Suzhou (CN); Xiaofei Li, Suzhou (CN)

(21) Appl. No.: 19/295,634

(22) Filed: Aug. 10, 2025

(30) Foreign Application Priority Data
Aug. 16, 2024 (CN) 2024 1112 7215.X

(51) Int. Cl. H02J 7/34; H02J 7/00

(52) U.S. Cl. CPC H02J 7/345; H02J 7/0047; H02J 7/00714; H02J 2207/50; H02J 2310/40

(57) ABSTRACT

A charging circuit, charging method, and system for an energy storage capacitor are disclosed. The charging circuit includes a current regulation module and a feedback control module. The feedback control module is configured to (i) determine a current measurement result, wherein the current measurement result is used to indicate the magnitude of the present charging current output by the current regulation module to the energy storage capacitor, and (ii) output a control signal to the current regulation module based on the current measurement result, the present voltage of the energy storage capacitor, and the input voltage received by the current regulation module, wherein the control signal corresponds to a target charging current. The current regulation module is configured to output the target charging current based on the control signal and the input voltage.

This application claims priority under 35 U.S.C. § 119 to application no. CN 2024 1112 7215.X, filed on Aug. 16, 2024 in China, the disclosure of which is incorporated herein by reference in its entirety.

The present disclosure relates to charging technology, and more specifically, to a charging circuit, charging method, airbag control system, and vehicle for an energy storage capacitor.

### BACKGROUND

Nowadays, with the improvement of vehicle performance, the driving speed of vehicles has greatly increased, and as a result, vehicle safety has received heightened attention. As a safety feature, airbags have gradually become widespread in various vehicles. Currently, in the design of airbag systems, energy storage capacitors are typically provided. During normal vehicle operation, the energy storage capacitor can be charged; in the event of a collision where the airbag needs to be deployed, if the main power supply is disconnected or damaged, the energy storage capacitor can serve as a backup power source to ensure airbag deployment, thereby improving the reliability of the airbag system. Therefore, how to efficiently realize the charging of the energy storage capacitor has become one of the issues of concern.

### SUMMARY

In view of the above issues, embodiments of the present disclosure provide a charging circuit, charging method, airbag control system, and vehicle for an energy storage capacitor.

On one aspect, embodiments of the present disclosure provide a charging circuit for an energy storage capacitor, comprising: a current regulation module and a feedback control module. The feedback control module is configured to: determine a current measurement result, wherein the current measurement result is used to indicate the magnitude of the present charging current output by the current regulation module to the energy storage capacitor; output a control signal to the current regulation module based on the current measurement result, the present voltage of the energy storage capacitor, and the input voltage received by the current regulation module, wherein the control signal corresponds to a target charging current. the current regulation module is configured to: output the target charging current based on the control signal and the input voltage.

On another aspect, embodiments of the present disclosure provide a method for charging an energy storage capacitor using the above charging circuit.

On another aspect, embodiments of the present disclosure provide an airbag control system, comprising: an energy storage capacitor and the above charging circuit.

On another aspect, embodiments of the present disclosure provide a vehicle, comprising the above airbag control system and a power supply, wherein the power supply is configured to provide an input voltage to the airbag control system.

### BRIEF DESCRIPTION OF THE DRAWINGS

A more detailed description of exemplary embodiments of the present disclosure is provided in conjunction with the drawings, in which the purposes, features, and advantages of the exemplary embodiments of the present disclosure and others will become apparent. Wherein, in the various drawings, the same reference numerals generally represent the same elements.

FIG. 1 illustrates a schematic diagram of an example of a vehicle according to some embodiments.

FIG. 2 illustrates a schematic diagram of an example of an airbag control system according to some embodiments.

FIG. 3 illustrates a schematic diagram of an example of a charging circuit according to some embodiments.

FIG. 4 illustrates a schematic diagram of an example of a charging circuit according to some embodiments.

FIG. 5 illustrates a schematic diagram of an example of a charging circuit according to some embodiments.

FIG. 6 illustrates a schematic diagram of an example of a charging circuit according to some embodiments.

FIG. 7 illustrates a schematic flowchart of a charging method for an energy storage capacitor according to some embodiments.

### DETAILED DESCRIPTION

The subject matter described herein is hereby discussed with reference to various examples. It should be understood that discussions about these examples are provided to aid those skilled in the art in better understanding and realization of the subject matter described herein rather than limiting the scope of protection, applicability, or examples described in the patent claims.

The energy storage capacitor is an important component in the control system of an airbag system, capable of providing emergency power supply in the event of power disconnection or failure, thereby ensuring the reliability of the airbag system. The energy storage capacitor may be charged by a power supply provided in the vehicle; however, how to efficiently charge the capacitor remains one of the issues to be addressed.

In view of the foregoing, embodiments of the present disclosure provide technical solutions for charging the energy storage capacitor. The description is given below with reference to the specific examples.

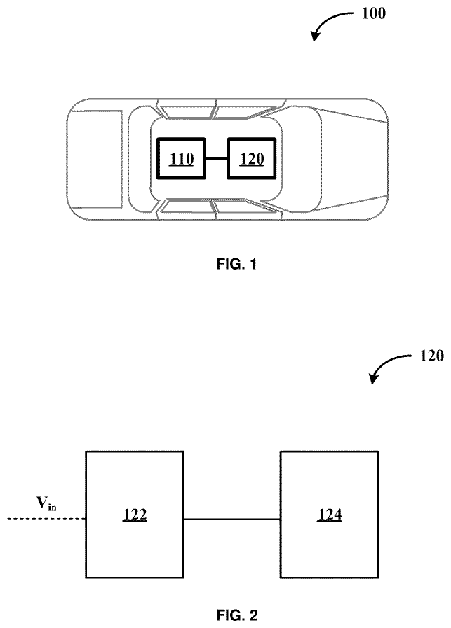

FIG. 1 illustrates a schematic diagram of an example of a vehicle according to some embodiments.

In the example of FIG. 1, the vehicle 100 may include a power supply 110. The power supply 110 may provide power to various systems or components of the vehicle 100. For example, the power supply 110 may comprise a battery or other power supply device installed on the vehicle 100. The voltage of the power supply 110 may be preset, such as 12 volts (V), 24V, or 48V, among others.

The vehicle 100 may further include an airbag control system 120. The airbag control system 120 may be part of the airbag system of the vehicle 100. For simplicity of illustration, the airbag system itself is not shown in FIG. 1. The airbag control system 120 may process various signals within the airbag system, control the operation of various components of the airbag system, and so forth. Similarly, the power supply 110 may provide power to the airbag control system 120.

It should be understood that the example of FIG. 1 is provided solely to facilitate understanding. In practical implementation, the vehicle 100 may include various systems or components, and is not limited to the example shown in FIG. 1.

FIG. 2 illustrates a schematic diagram of an example of an airbag control system according to some embodiments.

In the example of FIG. 2, the airbag control system 120 may include a charging circuit 122 and an energy storage capacitor 124. The charging circuit 122 may receive an input voltage Vin. The input voltage Vin may also be understood as the voltage at the input terminal of the charging circuit 122. In some embodiments, the charging circuit 122 may be directly connected to the power supply 110, thereby directly receiving the input voltage Vin from the power supply 110. In some embodiments, other components (such as a boost circuit, buck circuit, etc.) may be provided between the charging circuit 122 and the power supply 110. In such cases, these other components may receive the voltage from the power supply 110 and then provide the input voltage Vin to the charging circuit 122 either directly or after some conversion. Therefore, in embodiments of the present disclosure, the input voltage Vin received by the charging circuit 122 may come directly or indirectly from the power supply 110, and this is not limited herein. In any case, the charging circuit 122 may charge the energy storage capacitor 124 based on the input voltage.

In some cases, the input voltage Vin may be lower than the rated voltage of the energy storage capacitor 124. For example, the input voltage Vin may be 12V, while the rated voltage of the energy storage capacitor 124 may be 33V. In some cases, the input voltage Vin may be higher than the rated voltage of the energy storage capacitor 124. For example, the input voltage Vin may be 48V, while the rated voltage of the energy storage capacitor 124 may be 33V. The charging speed of the energy storage capacitor 124 is related to the magnitude of the charging current, which is constrained by the input voltage. Therefore, generally, the higher the input voltage, the greater the charging current, and thus the faster the charging speed of the energy storage capacitor 124. For example, compared to the case where the input voltage is 12V, the charging time of the energy storage capacitor 124 will be shorter when the input voltage is 48V.

It should be understood that the example of FIG. 2 is provided solely to facilitate understanding.

In practical implementation, the airbag control system 120 may include various other components and is not limited to the example shown in FIG. 2. For example, the airbag control system 120 may further include sensors, gas generators, controllers, and various other components, and this is not limited herein.

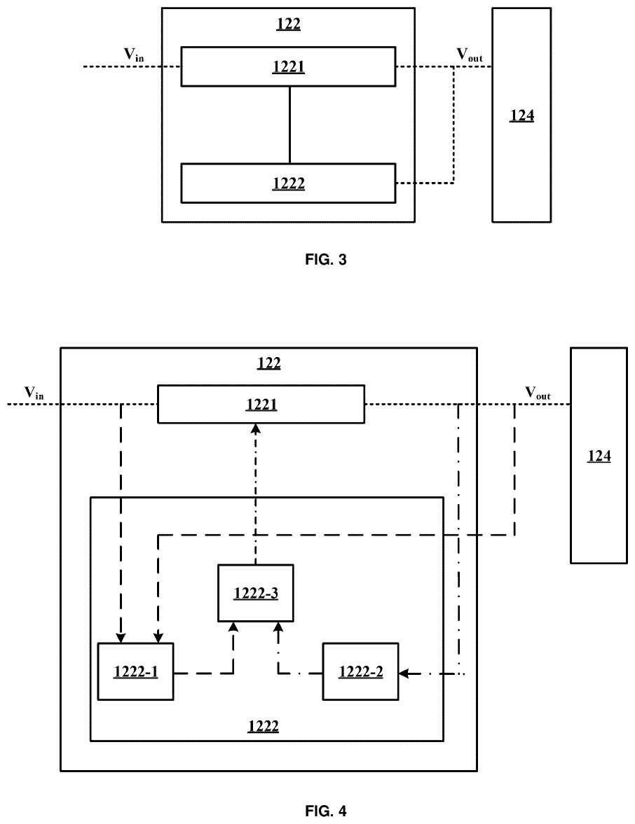

FIG. 3 illustrates a schematic diagram of an example of a charging circuit according to some embodiments.

In the example of FIG. 3, the charging circuit 122 may include a current regulation module 1221 and a feedback control module 1222.

The current regulation module 1221 may receive the input voltage Vin. As previously described, the input voltage Vin may come directly or indirectly from the power supply 110. The current regulation module 1221 may charge the energy storage capacitor 124 based on the input voltage Vin. For example, the current regulation module 1221 may output a charging current for charging the energy storage capacitor 124 based on the input voltage Vin.

The feedback control module 1222 may control the current regulation module 1221 such that the current regulation module 1221 outputs an expected charging current, hereinafter referred to as the target charging current. In some embodiments, the feedback control module 1222 may determine a current measurement result. The current measurement result may indicate the magnitude of the current charging current output by the current regulation module 1221 to the energy storage capacitor 124. The feedback control module 1222 may acquire the input voltage Vin. The feedback control module 1222 may also acquire the present voltage of the energy storage capacitor 124. The present voltage of the energy storage capacitor 124 is in fact also the output voltage of the charging circuit 122, denoted herein as Vout. The feedback control module 1222 may, based on the current measurement result, the present voltage Vout of the energy storage capacitor 124, and the input voltage Vin, output a control signal to the current regulation module 1221. The control signal may correspond to the target charging current. Thus, the current regulation module 1221 may output the target charging current based on the control signal and the input voltage Vin.

It can be seen that, in such embodiments, by monitoring the current charging current and the present voltage of the energy storage capacitor, and controlling the current regulation module to output the desired target charging current, reliable and efficient charging of the energy storage capacitor can be achieved.

In some embodiments, the feedback control module 1222 may determine an expected current result based on the voltage difference between the input voltage Vin and the present voltage Vout of the energy storage capacitor 124. The expected current result may indicate the magnitude of the target charging current. Then, the feedback control module 1222 may output a control signal based on the expected current result and the current measurement result.

It will be understood that, as the energy storage capacitor 124 is charged, its voltage continuously increases, and thus the aforementioned voltage difference also continuously changes. The feedback control module 1222 outputs the control signal based on this voltage difference, effectively adapting the charging current to the continuously changing voltage difference, thereby efficiently increasing the charging speed of the energy storage capacitor 124.

In some embodiments, the target charging current may be the maximum charging current based on the above voltage difference under the maximum power that the current regulation module 1221 can withstand. The voltage difference is, in fact, also the voltage applied across the current regulation module 1221. Therefore, under the maximum power that the current regulation module 1221 can withstand, the currently permissible maximum charging current can be determined based on the present voltage difference. By controlling the current regulation module 1221 to charge the energy storage capacitor 124 at the currently permissible maximum charging current, the charging speed of the energy storage capacitor 124 can be greatly increased, thereby saving charging time. Moreover, since the maximum power that the current regulation module 1221 can withstand is taken into account, the power consumption of the current regulation module 1221 can also be kept within its power limit, thus ensuring the safety of the current regulation module 1221 during the charging process.

The aforementioned expected current result, current measurement result, and control signal can be characterized by various suitable physical quantities. For example, the expected current result, current measurement result, and control signal may be characterized by voltage. By characterizing these results and control signals in this manner, the implementation of the charging circuit can be simplified.

In some embodiments, the feedback control module 1222 may include various submodules. FIG. 4 illustrates a schematic diagram of an example of a charging circuit according to some embodiments.

In the example of FIG. 4, the feedback control module 1222 may include a voltage difference conversion submodule 1222-1, a current measurement submodule 1222-2, and a drive submodule 1222-3.

The voltage difference conversion submodule 1222-1 may receive the input voltage Vin. Additionally, the voltage difference conversion submodule 1222-1 may be connected to the energy storage capacitor 124 to receive the present voltage Vout of the energy storage capacitor 124. The voltage difference conversion submodule 1222-1 may generate an expected current result based on the voltage difference between the input voltage Vin and the present voltage Vout of the energy storage capacitor 124, and output the expected current result to the drive submodule 1222-3.

The current measurement submodule 1222-2 may be connected to the current regulation module 1221 and the energy storage capacitor 124. The current measurement submodule 1222-2 may generate a current measurement result and output the current measurement result to the drive submodule 1222-3.

The drive submodule 1222-3 may be connected to the current regulation module 1221. The drive submodule 1222-3 may output a control signal to the current regulation module 1221 based on the expected current result and the current measurement result.

The specific implementations of each submodule are described below by way of example. It should be understood that the following examples do not in any way limit the scope of the present disclosure.

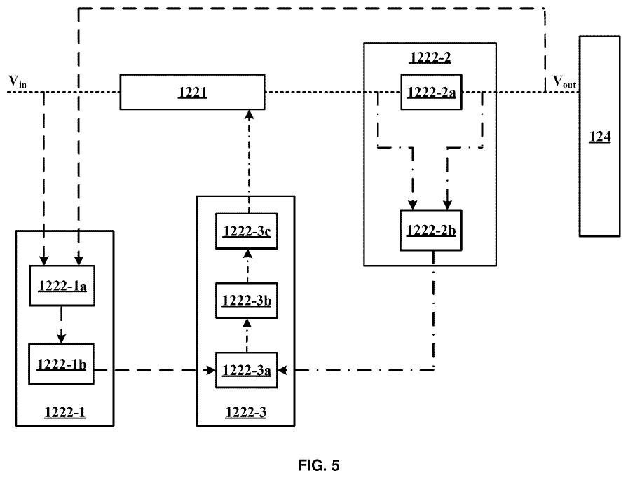

FIG. 5 illustrates a schematic diagram of an example of a charging circuit according to some embodiments.

As shown in FIG. 5, the voltage difference conversion submodule 1222-1 may include a first amplification unit 1222-1a and a voltage-to-resistance conversion unit 1222-1b.

A first input terminal of the first amplification unit 1222-1a may receive the input voltage Vin. A second input terminal of the first amplification unit 1222-1a may be connected to the energy storage capacitor 124 to receive the present voltage Vout of the energy storage capacitor 124. The output terminal of the voltage-to-resistance conversion unit 1222-1b may be connected to the drive submodule 1222-3. As described below, the output terminal of the voltage-to-resistance conversion unit 1222-1b may be connected to a third amplification unit 1222-3a of the drive submodule 1222-3.

The first amplification unit 1222-1a may amplify the voltage difference between the input voltage Vin and the present voltage Vout of the energy storage capacitor 124, and output the amplified voltage difference to the voltage-to-resistance conversion unit 1222-1b. The voltage-to-resistance conversion unit 1222-1b may convert the amplified voltage difference into a corresponding resistance value, and output an expected current result (e.g., expressed as a voltage) corresponding to this resistance value to the drive submodule 1222-3 (specifically, the third amplification unit 1222-3a). The amplification factor of the first amplification unit 1222-1a may be set based on the maximum power of the current regulation module 1221. Thus, the expected current result generated by the voltage-to-resistance conversion unit 1222-1b will correspond to the maximum charging current permitted under the current voltage difference at the maximum power.

The current measurement submodule 1222-2 may include a sensing unit 1222-2a and a second amplification unit 1222-2b.

The sensing unit 1222-2a may be connected between the output terminal of the current regulation module 1221 and the energy storage capacitor 124. Additionally, the sensing unit 1222-2a may be connected between the first and second input terminals of the second amplification unit 1222-2b. The output terminal of the second amplification unit 1222-2b is connected to the drive submodule 1222-3. As described below, the output terminal of the second amplification unit 1222-2b may be connected to the third amplification unit 1222-3a of the drive submodule 1222-3.

The sensing unit 1222-2a may sense the present charging current output from the current regulation module 1221. The second amplification unit 1222-2b may measure the present charging current sensed by the sensing unit 1222-2a, and output a current measurement result (e.g., expressed as a voltage) corresponding to the measured present charging current to the drive submodule 1222-3 (specifically, the third amplification unit 1222-3a).

The drive submodule 1222-3 may include a third amplification unit 1222-3a, an isolation unit 1222-3b, and a drive unit 1222-3c.

A first input terminal of the third amplification unit 1222-3a may be connected to the voltage-to-resistance conversion unit 1222-1b, and a second input terminal may be connected to the second amplification unit 1222-2b. The isolation unit 1222-3b may be connected between the output terminal of the third amplification unit 1222-3a and the input terminal of the drive unit 1222-3c. The output terminal of the drive unit 1222-3c may be connected to the current regulation module 1221.

The third amplification unit 1222-3a may generate an intermediate result (e.g., a voltage) based on the expected current result from the voltage-to-resistance conversion unit 1222-1b and the current measurement result from the second amplification unit 1222-2b, and output this intermediate result to the isolation unit 1222-3b. The primary function of the isolation unit 1222-3b is to prevent interference between the output terminal of the third amplification unit 1222-3a and the input terminal of the drive unit 1222-3c. The isolation unit 1222-3b transmits the intermediate result from the third amplification unit 1222-3a to the drive unit 1222-3c. The drive unit 1222-3c may, based on this intermediate result, output the control signal (for example, a voltage) to the current regulation module 1221, thereby controlling the current regulation module 1221 to output the target charging current.

It can be seen that, in the above structure, by regulating the charging current according to the voltage difference between the input voltage and the present voltage of the energy storage capacitor, so as to reach the currently allowable maximum charging current, the charging time of the energy storage capacitor can be greatly shortened.

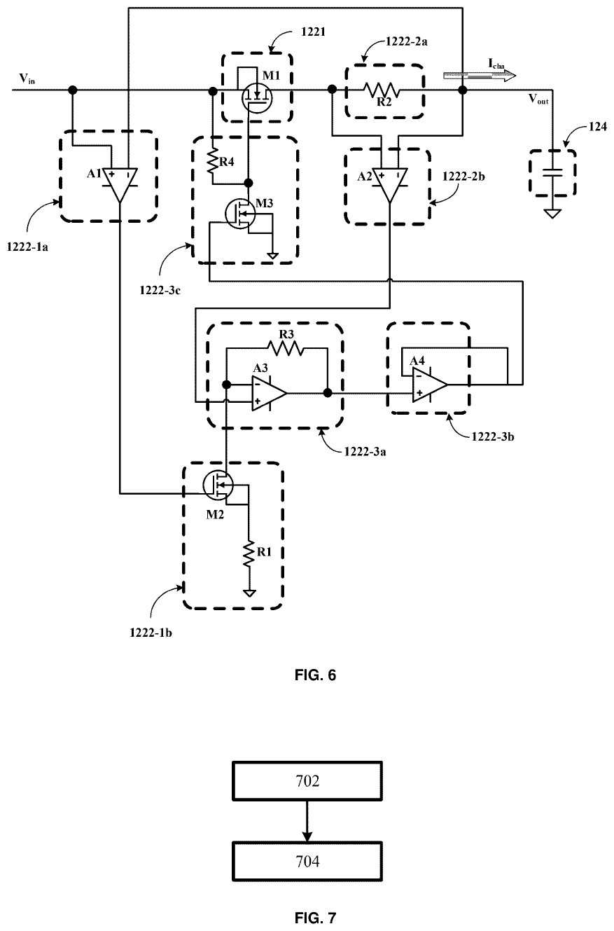

FIG. 6 illustrates a schematic diagram of an example of a charging circuit according to some embodiments.

In the example of FIG. 6, the charging current Icha is indicated by arrows. As shown, the charging current Icha flows from the input voltage Vin side to the energy storage capacitor 124 via the current regulation module 1221.

The current regulation module 1221 may comprise a metal-oxide-semiconductor field-effect transistor (MOSFET) M1, which may also simply be referred to as MOS transistor M1. MOS transistor M1 may be an N-type MOS (NMOS) transistor. Of course, MOS transistor M1 may also be a P-type MOS (PMOS) transistor. The drain current of MOS transistor M1 is the charging current Icha.

The first amplification unit 1222-1a may comprise a differential amplifier A1. One input terminal of the differential amplifier A1 is connected to the input voltage Vin, and the other input terminal is connected to the energy storage capacitor 124. The voltage-to-resistance conversion unit 1222-1b may comprise MOS transistor M2 and resistor R1. MOS transistor M2 may be an NMOS transistor. Alternatively, MOS transistor M2 may be a PMOS transistor. The gate of MOS transistor M2 is connected to the output terminal of differential amplifier A1, the source is connected to resistor R1, and the drain is connected to one input terminal of amplifier A3, as described below.

Differential amplifier A1 may amplify the voltage difference between the input voltage Vin and the present voltage Vout of the energy storage capacitor 124; for example, the amplification factor may be set based on the maximum power that MOS transistor M1 can withstand. Differential amplifier A1 may output the amplified voltage difference to the gate of MOS transistor M2, thereby controlling MOS transistor M2 to operate in the resistive region. At this time, the drain voltage of MOS transistor M2 may correspond to the currently allowable maximum charging current.

The sensing unit 1222-2a may comprise resistor R2. As shown in FIG. 6, the current flowing through resistor R2 is the present charging current flowing to the energy storage capacitor 124. Therefore, resistor R2 may be understood as a current sensing resistor. The second amplification unit 1222-2b may comprise a differential amplifier A2. The two input terminals of differential amplifier A2 are respectively connected to both ends of resistor R2, and the output terminal is connected to one input terminal of amplifier A3, as described below.

Differential amplifier A2 may measure the present charging current flowing through resistor R2 via its two input terminals and output a corresponding voltage. In other words, the magnitude of the present charging current is characterized by the voltage output by differential amplifier A2.

The third amplification unit 1222-3a may comprise amplifier A3 and resistor R3. As previously described, one input terminal of amplifier A3 is connected to the drain of MOS transistor M2, and the other input terminal is connected to the output terminal of differential amplifier A2. Resistor R3 is connected between one input terminal and the output terminal of amplifier A3, serving as a feedback resistor. The isolation unit 1222-3b may comprise an isolation amplifier A4. The drive unit 1222-3c may comprise MOS transistor M3 and resistor R4.

Amplifier A3 may compare and amplify the voltage corresponding to the currently allowable maximum charging current and the voltage corresponding to the present charging current, and the output voltage is referred to herein as the intermediate voltage. Amplifier A3 may output this intermediate voltage to one input terminal of isolation amplifier A4. The main function of isolation amplifier A4 is to isolate the output terminal of amplifier A3 from the gate of MOS transistor M3, in order to prevent mutual interference. Isolation amplifier A4 transmits the intermediate voltage output by amplifier A3 to the gate of MOS transistor M3, thereby controlling MOS transistor M3 to operate in the resistive region. In conjunction with resistor R4, this allows adjustment of the drain voltage of MOS transistor M1, thereby changing the drain current of MOS transistor M1, i.e., the charging current.

It should be understood that the above merely provides one specific implementation for each unit, and in different implementations, each unit may also be realized by various other devices, which is not limited herein.

It can be seen that, through such a charging circuit, the charging current can be adapted to the currently allowable maximum charging current according to the voltage difference between the input voltage and the present voltage of the energy storage capacitor, under the maximum power of the current regulation module, thereby achieving rapid charging of the energy storage capacitor. This can, in fact, be understood as a constant power charging mode.

Embodiments of the present disclosure further provide a charging method for an energy storage capacitor, which may be implemented by the charging circuit described above. For example, FIG. 7 illustrates a schematic flowchart of a charging method for an energy storage capacitor according to some embodiments.

In step 702, a current measurement result may be determined. The current measurement result may indicate the magnitude of the present charging current output to the energy storage capacitor.

In step 704, the target charging current may be output based on the current measurement result, the present voltage of the energy storage capacitor, and the input voltage.

The specific implementation of each step may refer to the process described above for the charging circuit and will not be repeated here.

The above, in conjunction with the drawings, details various optional embodiments of the present disclosure. However, the examples of the present disclosure are not limited to the specific details of the examples mentioned above. Within the technical scope of the examples of the present disclosure, various modifications to the technical solutions of the examples of the present disclosure are possible, and these modifications fall within the protection scope of the examples of the present disclosure.

What is claimed is:

1. A charging circuit for an energy storage capacitor, comprising:
a current regulation module and a feedback control module, wherein:
the feedback control module is configured to:
determine a current measurement result, wherein the current measurement result is used to indicate the magnitude of the present charging current output by the current regulation module to the energy storage capacitor, and
output a control signal to the current regulation module based on the current measurement result, the present voltage of the energy storage capacitor, and the input voltage received by the current regulation module, wherein the control signal corresponds to a target charging current, and
the current regulation module is configured to:
output the target charging current based on the control signal and the input voltage.

2. The charging circuit according to claim 1, wherein the feedback control module is further configured to:
determine an expected current result based on a voltage difference between the input voltage and the present voltage of the energy storage capacitor, wherein the expected current result is used to indicate the magnitude of the target charging current, and
output the control signal based on the expected current result and the current measurement result.

3. The charging circuit according to claim 2, wherein the target charging current is the maximum charging current based on the voltage difference under the maximum power that the current regulation module can withstand.

4. The charging circuit according to claim 2, wherein:
the feedback control module comprises a voltage difference conversion submodule, a current measurement submodule, and a drive submodule,
the voltage difference conversion submodule is configured to receive the input voltage and is connected to the energy storage capacitor, the current measurement submodule is connected to the current regulation module and the energy storage capacitor, and the drive submodule is connected to the current regulation module,
the voltage difference conversion submodule is configured to generate the expected current result based on the voltage difference between the input voltage and the present voltage of the energy storage capacitor, and output the expected current result to the drive submodule,
the current measurement submodule is configured to generate the current measurement result and output the current measurement result to the drive submodule, and
the drive submodule is configured to output the control signal to the current regulation module based on the expected current result and the current measurement result.

5. The charging circuit according to claim 4, wherein the expected current result, the current measurement result, and the control signal are characterized by voltages.

6. The charging circuit according to claim 4, wherein:
the voltage difference conversion submodule comprises a first amplification unit and a voltage-to-resistance conversion unit, and
a first input terminal of the first amplification unit is configured to receive the input voltage, a second input terminal of the first amplification unit is connected to the energy storage capacitor, an output terminal of the first amplification unit is connected to an input terminal of the voltage-to-resistance conversion unit, and an output terminal of the voltage-to-resistance conversion unit is connected to the drive submodule.

7. The charging circuit according to claim 6, wherein the amplification factor of the first amplification unit is set based on the maximum power that the current regulation module can withstand.

8. The charging circuit according to claim 6, wherein:
the first amplification unit comprises a first differential amplifier, and/or
the voltage-to-resistance conversion unit comprises a first metal-oxide-semiconductor field-effect transistor (MOSFET) and a first resistor.

9. The charging circuit according to claim 4, wherein:
the current measurement submodule comprises a sensing unit and a second amplification unit,
the sensing unit is connected between an output terminal of the current regulation module and the energy storage capacitor, and is connected between a first input terminal and a second input terminal of the second amplification unit, and
an output terminal of the second amplification unit is connected to the drive submodule.

10. The charging circuit according to claim 9, wherein:
the second amplification unit comprises a second differential amplifier, and/or
the sensing unit comprises a second resistor.

11. The charging circuit according to claim 4, wherein:
the drive submodule comprises a third amplification unit, an isolation unit, and a drive unit,
a first input terminal of the third amplification unit is connected to the voltage difference conversion submodule, and a second input terminal of the third amplification unit is connected to the current measurement submodule,
the isolation unit is connected between an output terminal of the third amplification unit and an input terminal of the drive unit, and
an output terminal of the drive unit is connected to the current regulation module.

12. The charging circuit according to claim 11, wherein:
the isolation unit comprises an isolation amplifier, and/or
the drive unit comprises a second metal-oxide-semiconductor field-effect transistor (MOSFET) and a third resistor.

13. The charging circuit according to claim 1, wherein the current regulation module comprises a third metal-oxide-semiconductor field-effect transistor (MOSFET).

14. The charging circuit according to claim 1, wherein the input voltage is greater than the rated voltage of the energy storage capacitor.

15. A method for charging an energy storage capacitor using the charging circuit according to claim 1.

16. An airbag control system, comprising:
an energy storage capacitor; and
the charging circuit according to claim 1.

17. A vehicle, comprising:
the airbag control system according to claim 16; and
a power supply configured to provide an input voltage to the airbag control system.
